(19) United States
(12) Patent Application Publication
(10) Pub. No.: US 2008/0279492 A1
(43) Pub. Date: Nov. 13, 2008

(54) Fluid Dynamic Bearing Mechanism

(75) Inventor: Rikuro Obara, Kitasaku-gun (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: NMB (USA), INC., Chatsworth, CA (US); MINEBEA CO., LTD., Nagano-Ken (JP)

(21) Appl. No.: 10/576,574

(22) PCT Filed: Aug. 17, 2004
(86) PCT No.: PCT/US2004/026628

§ 371 Date: Jul. 25, 2008

(30) Foreign Application Priority Data
Nov. 4, 2003 (JP) 2003-374754

(51) Int. Cl. F16C 32/06; H02K 7/08; G11B 5/82

(52) U.S. Cl. 384/100; 310/90; 360/135; G9B/5.293

(57) ABSTRACT

A fluid dynamic bearing mechanism that can ensure bearing rigidity, reduce shaft loss torque, reduce power consumption, stabilize axial rotation, and improve rotational accuracy is disclosed. The fluid dynamic bearing mechanism being suitable for use in a hard disk drive. In the fluid dynamic bearing mechanism (equipped with a bearing case, endplate, and shaft) a cylindrical hole of the bearing case is changed to a stepped cylindrical hole that has a large diameter part and a small diameter part. The shaft is changed to a stepped shaft that has a large diameter part and a small diameter part. On the outer circumference of either the large diameter part of the stepped cylindrical hole, or the large diameter part of the stepped shaft, a first dynamic pressure groove is be formed. On the outer circumference of either the small diameter part of the stopped cylindrical hole or the small diameter part of the stepped shaft, a second dynamic pressure groove is being formed. On the surface of step part of the stepped cylindrical hole, the third dynamic pressure groove is formed. The small gaps that face each of the three dynamic pressure grooves are filled with a dynamic pressure generating lubricating oil.

### BACKGROUND OF THE INVENTION

1. Field of the Invention

The present invention relates to fluid dynamic bearing demonstrating bearing functionality especially for forces in both the radial and axial directions. More particularly, the invention relates to a fluid dynamic bearing that reduces shaft torque loss while maintaining bearing rigidity.

2. Description of Related Art

The trend in recent years is towards greater-capacity, smaller-sized office automation equipment such as computers, etc., which use spindle motors in drive mechanisms for peripheral devices such as hard disk drives, etc. Therefore, spindle motors that demonstrate reliability in terms of motor positioning accuracy (NRRO (asynchronous vibration)), noise, acoustic lifespan, and rigidity, etc, are in great demand.

In previous years, bearing devices formed by combining multiple ball bearings were commonly used in spindle motors. However, recently, the demand for increased recording capacity, improved shock resistance, low noise, high-speed data access, etc., in devices such as hard disk drives has become greater than ever. Improvements are being made in these spindle motor ball bearings in order to meet these demands. By improvements in the constituent materials of the ball bearings and in the processing accuracy of inner and outer wheels and revolving mechanisms, a level of improvement has been achieved in rotation accuracy. These improvements alone are not sufficient. The limitations inherent in revolving bearings have become recognized, and in order to deal with these, fluid dynamic bearings are being employed more and more.

A spindle motor equipped with a fluid dynamic bearing is portrayed in FIG. 7. This spindle motor 00 has a base 02, and a rotor hub 03 that rotates relative to base 02. A fluid dynamic bearing mechanism 01 is located in the gap between the base 02 and the rotor hub 03.

A sleeve 010 of the fluid dynamic bearing mechanism 01 is inserted and affixed to an inner surface of the cylindrical wall 07 of the central portion of base 02, and a rotating shaft 030, suspended from the rotor hub 03, is fit into the sleeve 010. Lubricating oil is filled in the very small gap between the sleeve 010 and rotating shaft 030. When the rotating shaft 030 rotates, dynamic pressure is generated in the oil through the workings of dynamic pressure grooves 051, 052 (e.g., Herringbone grooves) formed on the inner surface of sleeve 010. The dynamic pressure allows the rotating shaft 030 to be supported along the radial axis while still being free to rotate without coming in contact with the inner surface of sleeve 010. The dynamic pressure grooves 051, 052 are formed at two points, the top and bottom of the inner surface of sleeve 010. These dynamic pressure grooves are alternatively, on occasion, formed on the outer circumferential surface of the rotating shaft 030.

While not depicted in detail, dynamic pressure grooves (e.g. Herringbone grooves) are also formed on both the lower end of sleeve 010 and a top surface of a counter plate 020, which face the lower end surface and upper end surface, respectively, of the thrust ring 060 that is fit onto the bottom end of rotating shaft 030. The minute gaps between opposing surfaces where dynamic pressure grooves exist are filled with lubricating oil. Dynamic pressure is generated in the oil through the workings of the dynamic pressure grooves when the rotating shaft 030 rotates. This pressure allows the thrust ring 060 to be supported along the axial direction while still being free to rotate without coming in contact with either the top surface of counter plate 20 or the bottom end of sleeve 010. These dynamic pressure grooves in some cases may be formed on the bottom end and top end of thrust ring 060.

Accordingly, the base 02 supports the rotation of rotating shaft 030 through the fluid dynamic bearing mechanism 01. Other than that, the structure, etc., of the motor part that consists of a stator 05, a permanent magnet 06, etc., does not differ fundamentally from past spindle motors that utilize multiple ball bearing devices.

In the conventional fluid dynamic bearing mechanism 01, the rotating shaft 030 has the same diameter across its full length, and the sleeve 010 has a cylindrical hole with the same diameter across its full length. Such construction provides relatively low bearing rigidity in the lower section of the bearing in comparison to the upper section of the bearing and the shaft torque loss becomes greater and power is wastefully consumed. It is desirable for the fluid dynamic bearing mechanism to have high bearing rigidity when supporting the rotor hub 03. The rotating shaft as well as the cylindrical hole in the sleeve are stepped in some prior art bearings. (See Unexamined Patent Application Publication No. H6-159355, Unexamined Patent Application Publication No. H6-173943, Unexamined Patent Application Publication No. H10-281150). However, these publications fail to recognize the implication of a stepped shaft for bearing rigidity and shaft torque loss in relation to the bearing load.

In the conventional fluid dynamic bearing mechanism 01, when a disk is in place on a disk holding surface 04 of the rotor hub 03, the center of balance of the entire rotating section including the rotating shaft 030 is at a point Q located above the center of the rotating shaft 30 on the main axis of the rotating shaft 30. And weight F of the entire rotating section weighs down as gravity on this point Q. When the rotating shaft 030 is maintaining its default vertical position, weight F is the thrust directed at point R on the rotating shaft 030. Point R is the lowest point on the main axis of the rotating shaft 030. The resultant force T (formed in the dynamic pressure generator section created by the small gap formed by the lower surface of thrust ring 060 and the upper surface of counter plate 020) acts at Point R. The direction of resultant force T is upwards from the direction of point Q and opposite to thrust F. Because of this, thrust F and resultant force T cancel out one another, and rotating shaft 030 rises above the upper surface of counterplate 020 and rotates without any contact with the upper surface. If the rotating shaft 030 loses its vertical position, the direction in which weight F of the entire rotating section acts creates a moment to knock down the shaft 030, making the rotation of the rotating shaft 030 unstable, and degrading the accuracy of rotation. The moment that tries to knock down this rotating shaft 030 becomes greater as the distance between point Q and point R increases. For that reason, it is best that the position of point R be as close as possible to that of point Q.

In the conventional fluid dynamic bearing mechanism 01, because the thrust that acts on the rotating shaft 030 is received by the counterplate 020, if the finishing accuracy of the counter plate 020 and the accuracy of setting the counter plate 020 into the sleeve 010 are not adequate, the main axis of rotating shaft 030 and that of sleeve 010 will no longer be parallel to each other, making the rotation of rotating shaft 030 unstable and degrading the accuracy of rotations.

### SUMMARY OF THE INVENTION

The present invention aims to resolve the problems of the conventional fluid dynamic bearing mechanisms and to provide a fluid dynamic bearing mechanism (or alternatively a fluid dynamic bearing system), for applications such as hard disk drives, that stabilizes the rotation of the rotating shaft and further improve the accuracy of rotation, along with decreasing the shaft torque loss as much as possible, and cutting down on the consumption of power, while using a relatively simple setup to ensure bearing rigidity.

The fluid dynamic bearing mechanism of the present invention includes a cylindrical bearing case with a cylindrical hole at its center, an end plate that seals one end of said bearing case, a shaft that has at least one part inserted into and supported by the bearing housing formed by the bearing case and the end plate. The cylindrical hole of the bearing case has a large diameter part and a small diameter part. The shaft is a stepped shaft having a large diameter part and a small diameter part that respectively face the large diameter part and the small diameter part of the stepped cylindrical hole. A first dynamic pressure generating groove is formed on either the large diameter part of the stepped cylindrical hole or the outer circumferential surface of the large diameter part of the stepped shaft. A second dynamic pressure generating groove is formed on either the small diameter part of the stepped cylindrical hole or the outer circumferential surface of the small diameter of the stepped shaft. A third dynamic pressure generating groove is formed on an inner surface of the end plate or a bottom surface of the stepped shaft. Additionally, dynamic pressure generating groove can also be formed, preferably on either a step part, or alternatively, on a tapered part of the stepped cylindrical hole or the surface of a step part or a tapered part of the stepped shaft. Small gaps faced by each of the first dynamic pressure generating groove, the second dynamic pressure generating groove and the third dynamic pressure generating groove are filled with dynamic pressure generating lubricating oil. Another embodiment of the fluid dynamic bearing mechanism also includes a thrust ring. The bearing case in this embodiment has an expanded diameter part wherein the thrust ring is fitted. A dynamic pressure generating groove may also be formed on a step surface of the expanded diameter or an upper surface of the thrust ring. Another location for a dynamic pressure generating groove can be the upper surface of the endplate or a bottom surface of the thrust ring. Another embodiment of the fluid dynamic bearing mechanism can also include an annular ring that straddles the stepped shaft and the stepped cylindrical hole and prevents the shaft from coming out of the hole. The various embodiments of the fluid dynamic bearing mechanism can also include a slight local expansion of the diameter of the large diameter part of the cylindrical hole at the open end of the bearing case. The expansion of the diameter prevents oil leakage from the various dynamic pressure generating grooves.

On the side of the bearing case that is blocked by the endplate, a small diameter radial dynamic pressure bearing part is formed and on the opposite side, which requires a relatively high bearing rigidity due to the linking of load elements such as the rotor hub (rotational or fixed) to the end section of the shaft, a large diameter radial dynamic pressure bearing part is formed. In the small diameter radial dynamic pressure bearing part, the smaller the diameter, the smaller is the shaft torque loss and lower is the power consumption. Thus the simple stepped shaft provides decreasing shaft torque loss while ensuring the required bearing rigidity. Also, by decreasing the friction loss in the small diameter radial dynamic pressure bearing part, it is possible to decrease the moment that acts in the direction to push down the shaft, and decrease the moment oscillation of the shaft that is caused by this moment.

In the embodiments in which an axial or radial-axial dynamic pressure bearing part is formed in the area between the large diameter part and the small diameter part of the shaft, the position at which the resultant force (the force that receives the thrust that acts on the shaft) acts can be brought closer to the position of the overall center of balance of the shaft and the load elements supported by the shaft. The positioning of the axial or radial-axial dynamic pressure bearing part closer towards the center of shaft makes it possible to stabilize the rotation (relative rotation) of the rotating shaft and further improves the accuracy of rotation by use of a simple setup. Additionally, in another embodiment, two axial dynamic pressure bearing parts can be formed. These two axial dynamic bearing pressure bearing parts generate forces that balance each other and the thrust acting on the shaft, and also operate to consistently push the shaft against the endplate.

In some embodiments, an annular ring meant to prevent the shaft from falling out is inserted to span across the annular hollow groove formed by the cylindrical hole in the bearing case and the annular hollow groove formed by the outer circumferential surface of the shaft, so even if the fluid dynamic bearing mechanism is exposed to vibrations or shock, there is no risk of the shaft falling out of the bearing housing.

Further features and advantages will appear more clearly on a reading of the detailed description, which is given below by way of example only and with reference to the accompanying drawings wherein corresponding reference characters on different drawings indicate corresponding parts.

### BRIEF DESCRIPTION OF THE DRAWINGS

FIG. 1 is a vertical cross-sectional view of the fluid dynamic bearing mechanism that shows the first embodiment of the present invention.

FIG. 2 is a vertical cross-sectional view of the fluid dynamic bearing mechanism that shows the second embodiment of the present invention.

FIG. 3 is a vertical cross-sectional view of the fluid dynamic bearing mechanism that shows the third embodiment of the present invention.

FIG. 4 is a vertical cross-sectional view of the fluid dynamic bearing mechanism that shows the fourth embodiment of the present invention.

FIG. 5 is a vertical cross-sectional view of the fluid dynamic bearing mechanism that shows the fifth embodiment of the present invention.

FIG. 6 is a vertical cross-sectional view of the fluid dynamic bearing mechanism that shows the sixth embodiment of the present invention.

FIG. 7 is a vertical cross-sectional view of the axial rotating spindle motor that was used for the fluid dynamic bearing mechanisms in the past.

### DETAILED DESCRIPTION OF THE INVENTION

According to the present invention, a large diameter radial dynamic pressure bearing part is formed in the small gap facing the first dynamic pressure generating groove in the side opposite of the side where the bearing case is sealed by the end plate. A small diameter radial dynamic pressure bearing part is formed in the small gap facing the second dynamic pressure generating groove in the side where the bearing case is sealed by the end plate. A relatively high bearing rigidity is desirable on the large diameter side of the shaft due to having load members such as a rotor hub having a disk mounted on it connected to the end of the shaft having the large diameter. A relatively low bearing rigidity is required on the small diameter side of the shaft on the side where the bearing case is sealed by the end plate. Because of this, the diameter on a portion of the shaft is made smaller and thereby the friction loss in this small diameter radial dynamic pressure bearing part is reduced, which in turn results in the reduction of shaft torque loss. The simple stepped structure therefore allows the necessary bearing rigidity while reducing the shaft torque loss as much as possible and cutting power consumption.

Additionally, because the friction loss in the small diameter radial dynamic pressure bearing part can be reduced, the moment acting in the direction that the shaft will fall can be reduced, and so the shaft vibration resulting from this moment can also be reduced.

Additionally, an axial dynamic pressure bearing part is formed in the small gap facing the third dynamic pressure generating groove in the place where the step part of the stepped cylindrical hole of the bearing case and step part of the stepped shaft face each other. In this case, the axial dynamic pressure bearing part is positioned towards the center part of the shaft, and the position of the resultant force balancing the thrust acting on the shaft is brought closer to the combined overall position of the shaft and load members connected to the shaft. Therefore, the rotation of the shaft can be stabilized and rotational precision improved by a simple structure.

The first dynamic pressure generating groove is formed on either the large diameter part of the stepped cylindrical hole or the outer circumferential surface of the large diameter part of the stepped shaft. The second dynamic pressure generating groove is formed on either the small diameter part of the stepped cylindrical hole or the outer circumferential surface of the small diameter of the stepped shaft. The third dynamic pressure generating groove is formed preferably on either the step part or a tapered part of the stepped cylindrical hole or the surface of the step part or a tapered part of the stepped shaft. The small gaps faced by each of the first dynamic pressure generating groove, the second dynamic pressure generating groove and the third dynamic pressure generating groove are filled with dynamic pressure generating lubricating oil.

Also, because the axial dynamic pressure bearing part is not formed in the small gap between the inner surface of the endplate and the edge of the end of the shaft (in other words, the thrust that acts on the shaft is not set up to be received by the endplate), there is no risk associated with the finishing accuracy of the endplate and the accuracy of setting the endplate into the bearing case that may cause the main axis of the shaft and that of the bearing case to not be parallel to each other, the rotation of the shaft to become unstable, and the accuracy of the rotation to degrade. Also, by coating the upper surface of the endplate through sputtering, etc. and increasing the surface hardness, there is no need to increase the kinetic friction resistance of the rotating shaft with respect to times of operation and shutdown.

Furthermore, in the case where a thrust ring is affixed on one end of the shaft, an expanded diameter for receiving the thrust ring that is on the one end of the bearing case is formed on the cylindrical hole of the bearing case. A fourth dynamic pressure generating groove is formed on either the step part leading from said expanded diameter part or the upper surface of the thrust ring that faces the said step part. An axial dynamic pressure bearing part can be formed in the small gap facing the fourth dynamic pressure generating groove. When there is a need to maintain an appropriate gap for both small gaps facing the third dynamic pressure generating groove and fourth dynamic pressure generating groove to stabilize the rotation of the shaft, the force generated by this axial dynamic pressure bearing part, together with the force generated from either the axial dynamic pressure bearing part formed in the small gap facing the third dynamic pressure generating groove or the radial/axial dynamic pressure bearing part can be utilized as the force necessary to meet that need.

Various embodiments of the present invention are described hereafter.

### EMBODIMENT 1

The first embodiment (Embodiment 1) of the invention in this application is described below.

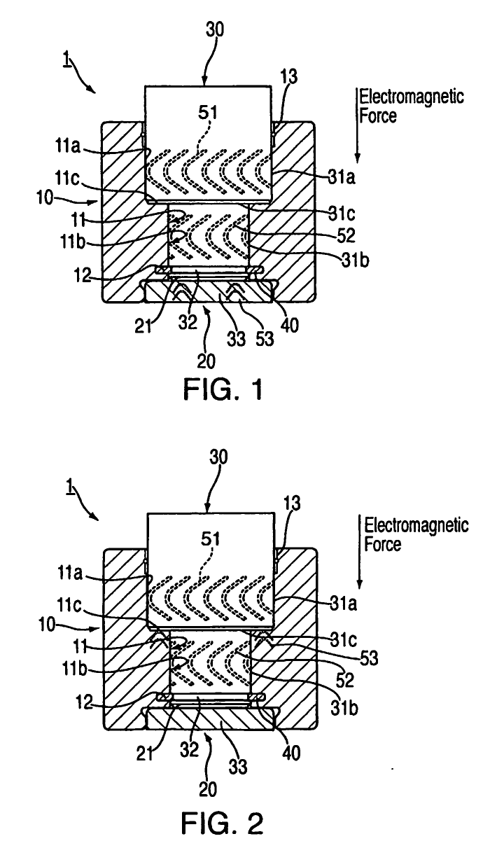

FIG. 1 shows a vertical cross-sectional view of a fluid bearing system 1 of the first embodiment. The fluid bearing system 1 of the first embodiment is equipped with a cylindrical bearing case 10 having a cylindrical hole 11 (11a, 11b) in its center, an end plate 20 that seals one end of the lower part of the bearing case 10 and a shaft 30 that has at least one part inserted into and supported by the bearing housing formed by bearing case 10 and end plate 20. The cylindrical hole 11 consists of a large part 11a and a small part 11b. The shaft 30 is connected to the rotating load unit not shown in the figure. The shaft 30 may be manufactured as an integral part of the rotating load unit. Additionally, in some cases, a fixed unit may be attached to the shaft 30 in place of the rotating unit. In this case, the bearing case 10 is the rotating side. Furthermore, in this specification, the side where one end of the bearing case 10 is sealed by end plate 20 is deemed as the lower part and the open side of the bearing housing as the top part.

The cylindrical hole 11 of the bearing case 10 is structured as a stepped cylindrical hole comprising the large diameter part 11a formed at the top of the bearing case 10 and the small diameter part 11b formed in a first end in the bottom part of bearing case 10. Furthermore, the shaft 30 is structured as a stepped shaft with a large diameter part 31a and a small diameter part 31b that respectively face the large diameter part 11a and the small diameter part 11b of the stepped cylindrical hole 11. In addition, a first dynamic pressure generating groove 51 is formed on the large diameter part 11a of the stepped cylindrical hole 11, and, furthermore, a second dynamic pressure generating groove 52 is formed on the small diameter part 11b of the stepped cylindrical hole 11, and, moreover, a third dynamic pressure generating groove 53 is formed on an inner surface 21 of the end plate 20.

Although the above dynamic pressure generating grooves 51-53 are formed in a herringbone pattern, they are not restricted to this pattern and may be formed, for example, in a spiral pattern or a straight-line pattern. Additionally, the first dynamic pressure generating groove 51, the second dynamic pressure generating groove 52, and the third dynamic pressure generating groove 53 may also be respectively formed on the outer circumferential surface of large diameter part 31a, on the outer circumferential surface of small diameter part 31b, and on the end surface (bottom edge) 33 of the stepped shaft 30. In between the large diameter part 11a and the small diameter part 11b of stepped the cylindrical hole 11 is a step part 11c, which is perpendicular to the surface of the hole 11. In between the large diameter part 31a and the small diameter part 31b of the stepped shaft 30 is a step part 31c, which is perpendicular to the outer circumferential surfaces of the stepped shaft 30.

The first dynamic pressure generating groove 51 faces a small gap that is formed between the large diameter part 11a of stepped cylindrical hole 11 and the outer circumferential surface of the large diameter part 31a of stepped shaft 30, and the small gap is filled with dynamic pressure generating lubricating oil. The second dynamic pressure generating groove 52 faces a small gap that is formed between the small diameter part 11b of stepped cylindrical hole 11 and the small diameter part 31b of stepped shaft 30, and the small gap is filled with dynamic pressure generating lubricating oil. Furthermore, the third dynamic pressure generating grooves 53 faces a small gap that is formed between the inner surface 21 of endplate 20 and the lower end 33 of shaft 30 and the small gap is filled with dynamic pressure generating lubricating oil.

Additionally, a circular ring 40, which is for preventing the shaft 30 from slipping out, is fitted in an annular groove 12 formed on the small diameter part 11b of stepped cylindrical hole 10 and an annular groove 32 formed on the outer circumferential surface of small diameter part 31b of the stepped shaft 30. The circular ring 40 prevents the shaft 30 from slipping out of the bearing housing when the dynamic fluid bearing mechanism 1 is subjected to vibration or shock.

A small gap is faced by the first dynamic pressure generating groove 51 and formed between the large diameter part 11a of the stepped cylindrical hole 11 and the outer circumferential surface of the large diameter part 31a of the stepped shaft 30. A portion of the large diameter part 11a is slightly expanded in diameter to make the gap between this expanded portion and the shaft 30 slightly wider than the small gap. The wider gap is at the open end of the bearing and forms a widened seal part 13. The dynamic pressure generating lubricating oil that is filled into the small gap faced by the first dynamic pressure generating groove 51 will not leak out from the small gap to the outside because the capillary phenomenon is blocked at the widened seal part 13.

The shaft 30 is always pushed in the direction of the end plate 20 (the lower part in FIG. 1) by the gravitational force (dead load) acting on the shaft 30. The gravitational force acting on the load members (rotor hub, disk, etc. not shown in the figure) is supported by the shaft 30. The electromagnetic force is generated by the electromagnetic drive unit (motor, which is not shown in the figure). The gravitational force and the electromagnetic force operate as the force in the axial direction (thrust). Even in the case in which the fluid bearing system 1 is used in a condition where top and bottom are reversed, in other words, where the shaft 30 is positioned at the lower part and end plate 20 at the top part, the shaft 30 will always be pushed in the direction of the end plate 20 by said electromagnetic force.

The embodiment 1 having a structure as described above can accomplish the following functions and effects.

When the electromagnetic drive unit (motor, which is not shown in the FIG. 1) installed to rotate the shaft 30 and the bearing case 10 in opposing directions is activated and the shaft 30 rotates in the direction opposite to the bearing case 10, the actions of the first dynamic pressure generating groove 51 and second dynamic pressure generating groove 52 cause the pressure of the lubricating oil in the small gaps (first and second radial dynamic pressure bearing parts) faced by each of these grooves to increase, and thus causes the shaft 30 to rise out of the stepped cylindrical hole 11 of the bearing case 10, i.e., move so as to eliminate any contact with the stepped cylindrical hole 11 in resting state. In this way, the force in the radial direction acting on shaft 30 is received by stepped cylindrical hole 10 and the shaft 30 rotates without coming into contact with the stepped cylindrical hole 11.

As the small gap (first radial dynamic pressure bearing part) faced by the first dynamic pressure groove 51 has a large diameter, it can provide a large amount of bearing rigidity and is suitable for providing stable rotational support for the load members (rotor hub, etc.) connected to the top end of the shaft 30. On the other hand, because the small gap facing the second dynamic pressure generating groove 52 (second radial dynamic pressure bearing part) has a small diameter, it cannot provide a large amount of bearing rigidity as compared to the first radial dynamic pressure bearing part. However, because the rotational support of the load members connected to the top end of the shaft 30 is mainly taken on by the first radial dynamic pressure bearing part, it is possible for the second radial dynamic pressure bearing part to have a small diameter, and thereby reduce the friction loss and the shaft torque loss. Therefore, it is possible through a simple structure to secure the necessary bearing rigidity while reducing the shaft torque loss as much as possible and reducing power consumption.

Additionally, due to the reduction of friction loss in the second radial dynamic pressure bearing part, the moment acting in the direction that pushes the shaft 30 can be reduced, and thus the moment vibration (the whirl vibration from the gyro of the shaft 30) of the shaft 30 caused by this moment is reduced.

Additionally, when the shaft 30 rotates in the direction opposite to the bearing case 10, the action in the third dynamic pressure generating groove 53 causes the pressure of the lubricating oil in the small gap (axial dynamic pressure bearing part) faced by said groove to increase, and thus causes the shaft 30 to rise out of the end plate 20. In this way, the force in the axial direction (thrust), which acts on the shaft 30, is received by the inner surface 21 of the end plate 20 and so the shaft 30 rotates without coming into contact with the end plate 20.

### EMBODIMENT 2

FIG. 2 shows a vertical cross-sectional view of a fluid bearing system 1 of a second embodiment (Embodiment 2) of the invention of this application and the parts corresponding to Embodiment 1 have been assigned the same codes.

As shown in FIG. 2, when the dynamic fluid bearing mechanism 1 (alternatively, the fluid bearing system 1) of Embodiment 2 is compared to Embodiment 1, the only difference is in the position where the third dynamic pressure generating groove 53 is formed. In other words, while in Embodiment 1 the third dynamic pressure generating groove 53 was formed on the inner surface 21 of the end plate 20, in Embodiment 2, the third dynamic pressure generating groove 53 is formed on the step part 11c of stepped cylindrical hole 11 of bearing case 10. In addition, the small gap faced by said third dynamic pressure generating groove 53 and formed between the step part 11c of stepped cylindrical hole 11 and the surface of the step part 31c of stepped shaft 30, is filled with lubricating oil to form the axial dynamic pressure bearing. The third dynamic pressure generating groove 53 can alternatively be formed on the surface of the step part 31c of stepped shaft 30.

The Embodiment 2 having a structure as described above can accomplish the following functions and effects.

Currently, when the electromagnetic drive unit (motor, which is not shown in the FIG. 2) is activated and the shaft 30 rotates in the direction opposite to the bearing case 10, the workings of the third dynamic pressure generating groove 53 causes the pressure of the lubricating oil in the small gap (axial dynamic pressure bearing part) faced by said groove to increase, thus causing the shaft 30 to rise above the step part 11c of bearing case 10. In this way, the force in the axial direction (thrust) acting on the shaft 30 is received by the step part 11c of the bearing case 10 and so the shaft 30 rotates without coming into contact with the step part 11c.

Consequently, the axial dynamic pressure bearing part is positioned towards the center part of the shaft 30. The position of the resultant force opposing the thrust acting on the shaft 30 is brought closer to the combined overall position of the shaft 30 and the load members (rotor hub, disk, etc.) supported by the shaft 30, and therefore the rotation of the shaft 30 is stabilized and rotational precision improved.

Additionally, because the axial dynamic pressure bearing part is not set up in the small gap between the inner surface 21 of end plate 20 and the end surface (the lower end surface in FIG. 2) of one end of shaft 30 (in other words, the thrust acting on shaft 30 is not fashioned so that it is received by the end plate 20), the finish precision of end plate 20 or the precision of assembling it onto the bearing case 10 will not cause the central axis of the shaft 30 and the central axis of bearing case 10 to be made unparallel, the rotation of the shaft 30 to become unstable, and the rotation accuracy to deteriorate. Additionally, it is also not necessary to coat the upper surface of end plate 20 by sputtering etc. to strengthen surface hardness to improve the sliding friction resistance between it and the rotating shaft 30 during start up and shut down.

Furthermore, with regard to the bearing rigidity, shaft torque loss, and moment vibration of the shaft 30, effects equivalent to that of Embodiment 1 can be achieved.

### EMBODIMENT 3

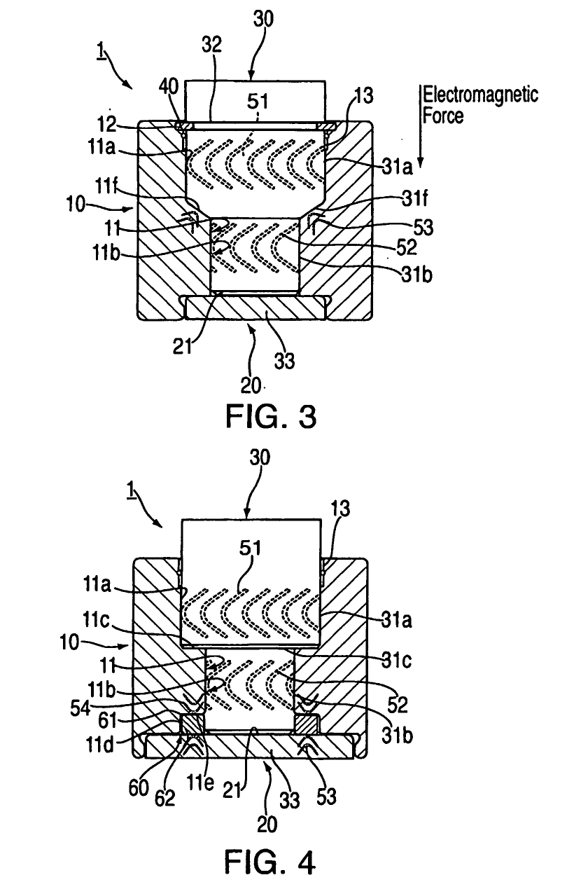

FIG. 3 is a diagram showing a vertical cross-sectional view of the present invention's third embodiment (Embodiment 3) of a fluid dynamic bearing mechanism 1, with the same labels for the parts that correspond with Embodiment 2.

The fluid dynamic bearing mechanism 1 of Embodiment 3 has a gradient in the bearing case 10's step part 11c of stepped-cylindrical hole 11. A step part 31c of stepped-shaft 30 has a tapered structure (designated by label 31f), such that the smaller side is in the direction of endplate 20. The third dynamic pressure groove 53 is formed at a tapered part 11f of the stepped cylindrical hole 11. The annular ring 40 is moved on the large-diameter part side of bearing case 10. Alternatively, the third dynamic pressure groove 53 can be formed on the external surface of the tapered part 31f of stepped-shaft 30.

In Embodiment 3, the small gap (which faces the third dynamic pressure groove 53) that is formed between the tapered part 11f and the external surface of tapered part 31f is filled with lubricating oil to form a radial-axial dynamic pressure bearing part. This radial-axial dynamic pressure bearing part sustains the force (thrust) in the axial direction operating on the shaft 30 and also sustains a portion of the force in the radial direction operating on the shaft 30.

The Embodiment 3, having a structure as described above, can accomplish the following operations and purposes.

With the electromagnetic drive unit (motor, which is not shown in the diagram) at work, as the shaft 30 rotates with respect to the bearing case 10, through the help of the first through third pressure grooves 51, 52 and 53, the small gap parts that these grooves face (first and second radial dynamic pressure bearing parts, radial/axial dynamic pressure bearing part) will experience a rise in lubricating oil pressure, and cause the shaft 30 to surface from the large diameter part 11a, small diameter part 11b and the tapered part 11f of the stepped-cylindrical hole 11. The force in the radial direction operating on the shaft 30 is sustained by the various parts of the stepped cylindrical hole 11, and the force in the axial direction (thrust) operating on the shaft 30 is sustained by the tapered part 11f of the stepped cylindrical hole 11. In addition, the shaft 30 will rotate without making any contact with these parts.

In this way, and especially due to the ability of the tapered part 11f of stepped-cylindrical hole 11 to sustain the force in the radial direction operating on the shaft 30, the necessary bearing rigidity can be further guaranteed along with the reduction in shaft torque loss and power consumption.

Furthermore, because the annular ring 40 is positioned in the bearing case 10 on the large diameter part side of the stepped shaft 30, the installment of the annular ring 40 is simplified, and the effectiveness of the seal of the lubricating oil is heightened. In addition, an effective performance equal to Embodiment 2 regarding the bearing rigidity, vibration moment and rotational accuracy of shaft 30, can be accomplished.

If difficulty is encountered in Embodiment 3 in forming the third dynamic pressure generating groove 53 due to the shortness in width of the external surface of the tapered part 11f of stepped cylindrical hole 11 or the tapered part 31f of stepped shaft 30, in the same way as in Embodiment 1, the third dynamic pressure groove 53 may be formed at the inner surface 21 of end plate 20, or the bottom surface 33 of stepped shaft 30.

The first through third embodiments (Embodiments 1-3) of the present invention, which were explained above, are ideal fluid dynamic bearing mechanisms for use when electromagnetic force is utilized to press the shaft 30 continuously against the end plate 20. In the event that this electromagnetic force cannot be relied upon in a fluid dynamic bearing mechanism, there is a concern that the rotating part will rise and cause an instability in the rotation. Embodiments 4-6 are concerned with fluid dynamic bearing mechanisms that are equipped with dynamic pressure bearing parts that can make use of force in the axial direction instead of this electromagnetic force.

### EMBODIMENT 4

FIG. 4 shows a fourth embodiment (Embodiment 4) of the present invention, and is a vertical cross-sectional view of a fluid dynamic bearing mechanism 1 with the same labels for parts that correspond with Embodiment 1.

As illustrated in FIG. 4, in the fluid dynamic bearing mechanism 1 of Embodiment 4, a thrust ring 60 is attached on one side of the shaft 30. The stepped cylindrical hole 11 of bearing case 10 has an expanded diameter part 11d to support the thrust ring 60 on one side of the bearing case 10. A fourth dynamic pressure groove 54 is formed on a step part 11e that connects to the said expanded diameter part 11d. The fourth dynamic pressure groove 54 can also be formed on an upper surface 61 of thrust ring 60.

Moreover, the axial dynamic pressure bearing part is formed in the small gap (which the third dynamic pressure groove 53 faces) between the inner surface 21 of endplate 20 and a bottom surface 62 of thrust ring 60. Consequently, the third dynamic pressure groove 53 in Embodiment 4 can be formed on either the inner surface 21 of endplate 20 that faces the bottom surface 62 of thrust ring 60, or the bottom surface 62 of thrust ring 60 itself. Furthermore, the annular ring 40 (that is used to prevent the shaft 30 from coming off) in Embodiment 1 is removed in Embodiment 4.

In terms of other issues, Embodiment 4 does not differ very much from Embodiment 1 in ways other than those described above, and therefore, detailed explanations are omitted.

Because Embodiment 4 is setup as described above, an additional axial dynamic pressure bearing part (the second axial dynamic pressure bearing part) is formed at the location where the step part 11c and the top surface 61 of thrust ring 60 face. The force generated by this second axial dynamic pressure bearing part will be in the direction that is opposite of the force that is generated by the axial dynamic pressure bearing part (first axial dynamic pressure bearing part) that is formed at the small gap that the third dynamic pressure axial groove 53 faces. Thus, the force generated by the second axial dynamic pressure bearing part will oppose the thrust on the shaft and will operate consistently to push the shaft 30 against the endplate 20. The result is the prevention of the rotating part (in the case of Embodiment 4, the shaft 30 and the load supported by the shaft 30) from surfacing, and the small gaps that the third dynamic pressure axial groove 53 and the fourth dynamic pressure axial groove 54 face respectively are appropriately maintained and the rotation of shaft 30 is stabilized.

Also, because the thrust ring 60 is supported by the expanded diameter part 11d of stepped cylindrical hole 11 of bearing case 10, shock and/or vibration of the fluid dynamic bearing mechanism 1 will not cause the shaft 30 to come out of the bearing housing. Additionally, the same effective performance as Embodiment 1 can be achieved.

### EMBODIMENT 5

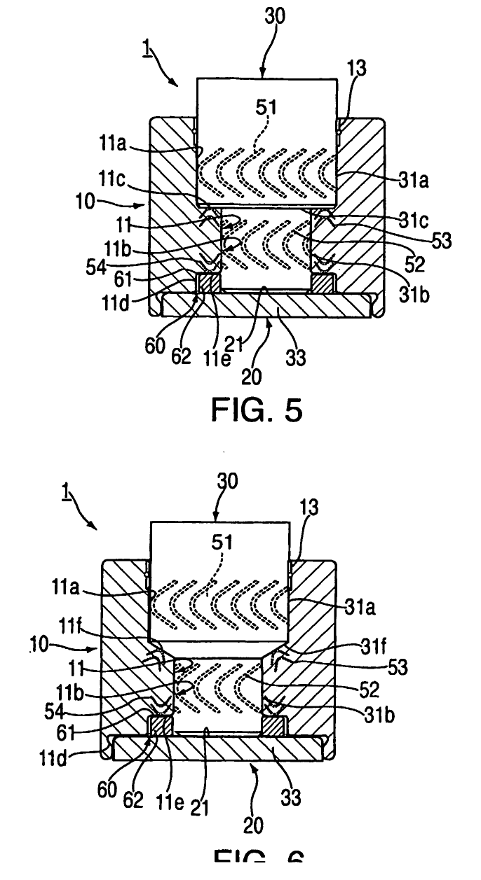

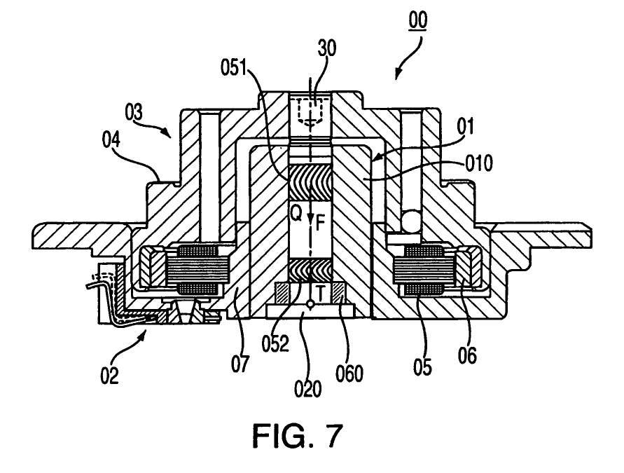

FIG. 5 shows a fifth embodiment (Embodiment 5) of the present invention, and is a vertical cross-sectional view of a fluid dynamic bearing mechanism 1 with the same labels for parts that correspond with Embodiment 4.

As illustrated in FIG. 5, the fluid dynamic bearing mechanism 1 of Embodiment 5 has the thrust ring 60 attached on one side of the shaft 30, and the stepped cylindrical hole 11 of bearing case 10 has the expanded diameter part 11d to support the thrust ring 60 on one side of the bearing case 10. The fourth dynamic pressure groove 54 is formed on the step part 11e that connects to the expanded diameter part ld. The fourth dynamic pressure groove 54 can also be formed on the upper surface 61 of thrust ring 60 that is opposite step part lI e. In addition, the annular ring 40 used to prevent the slipping of the shaft 30, as in Embodiment 2, is not used in Embodiment 5.

Because Embodiment 5 is set up in the above-noted way, an additional axial dynamic pressure bearing part (the second axial dynamic pressure bearing part) is formed between the stepped part 11c and the top surface 61 of thrust ring 60. The first dynamic pressure bearing part is formed between the step part 11c of stepped cylindrical hole 11 and the step part 31c of stepped shaft 30. In comparison to Embodiment 4, the location for the formation of the first dynamic pressure bearing part is different, however, it can achieve the same performance as Embodiment 4 in preventing the rotating part from surfacing. Also, in the same way as Embodiment 4, the shock and/or vibration will not cause the shaft 30 to come out of the bearing housing. Furthermore, with the exception of the effect of the annular ring 40 in preventing the shaft 30 from coming out, an effect similar to Embodiment 2 can be accomplished.

### EMBODIMENT 6

FIG. 6 is the sixth embodiment (Embodiment 6) of the present invention, and is a vertical cross-sectional view of a fluid dynamic bearing mechanism 1 with the same labels for parts that correspond with Embodiment 5.

As illustrated in FIG. 6, the fluid dynamic bearing mechanism 1 of Embodiment 6 adds to Embodiment 3 a second axial dynamic pressure bearing part, which is equivalent to the second axial dynamic pressure bearing part in Embodiment 5, and it also scraps the annular ring of Embodiment 3. In other ways, it does not differ from Embodiment 3 and therefore detailed explanations are omitted.

Because Embodiment 6 is set up in the above-noted way, an additional axial dynamic pressure bearing part (the second axial dynamic pressure bearing part) is formed between the stepped part 11c and the top surface 61 of thrust ring 60. In comparison to Embodiment 5, Embodiment 6 differs in that the location where the first axial dynamic pressure bearing part or the radial-axial dynamic pressure bearing part are formed is at the small gap that is formed between the step part 11c of stepped cylindrical hole 11, or at the small gap that is formed between the tapered portion 11f of stepped cylindrical hole 11 and the exterior portion of the tapered portion 31f of stepped shaft 30. However, as in Embodiment 5, it is able to accomplish the effect of preventing the rotating parts from surfacing. Also, in the same way as in Embodiment 5, shock and/or vibration will not cause the shaft 30 to come out of the bearing housing. Furthermore, with the exception of the effect of the annular ring 40 in preventing the shaft 30 from coming out, an effect similar to Embodiment 3 can be accomplished.

While preferred embodiments of the invention have been described, various modifications will be apparent to one skilled in the art in light of this disclosure and are intended to fall within the scope of the appended claims.

I claim:

1. A fluid dynamic bearing mechanism comprising:
a cylindrical bearing case;
a cylindrical hole formed in the bearing case, the cylindrical hole having a large diameter part and a small diameter part;
an end plate that seals one end of the bearing case to form a bearing housing;
a stepped shaft inserted in the bearing housing, the shaft having a large diameter part and a small diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either an inner surface of the end plate or a surface of one edge of the stepped shaft; and
lubricating oil filled in small gaps formed between facing surfaces adjacent to the first dynamic pressure groove, the second dynamic pressure groove, and the third dynamic pressure groove.

2. The fluid dynamic bearing mechanism of claim 1 further comprising:
an annular groove formed in the cylindrical hole;
a circular groove formed on the stepped shaft; and
an annular ring straddling the annular groove and the circular groove to prevent the stepped shaft from slipping out of the cylindrical hole.

3. The fluid dynamic bearing mechanism of claim 2 further comprising:
a widened section formed in the large diameter part of the cylindrical hole to form a widened seal part.

4. A fluid dynamic bearing mechanism comprising:
a cylindrical bearing case;
a stepped cylindrical hole formed in the bearing case, the cylindrical hole having a large diameter part, a small diameter part and a first step portion formed at the junction of the large diameter part and the small diameter part;
an end plate that seals one end of the bearing case to form a bearing housing;
a stepped shaft inserted in the bearing housing, the shaft having a large diameter part and a small diameter part and a second step portion formed at the junction of the large diameter part and the small diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first step portion or the second step portion; and
lubricating oil filled in small gaps formed between facing surfaces adjacent to the first dynamic pressure groove, the second dynamic pressure groove, and the third dynamic pressure groove.

5. The fluid dynamic bearing mechanism of claim 4 further comprising:
an annular groove formed in the cylindrical hole;
a circular groove formed on the stepped shaft; and
an annular ring straddling the annular groove and the circular groove to prevent the stepped shaft from slipping out of the cylindrical hole.

6. The fluid dynamic bearing mechanism of claim 5 further comprising:
a widened section formed in the large diameter part of the cylindrical hole to form a widened seal part.

7. A fluid dynamic bearing mechanism comprising:
a cylindrical bearing case;
a stepped cylindrical hole formed in the bearing case, the cylindrical hole having a large diameter part, a small diameter part and a first tapered part connecting the large diameter part and the small diameter part of the cylindrical hole;
an end plate that seals one end of the bearing case to form a bearing housing;
a stepped shaft inserted in the bearing housing, the shaft having a large diameter part, a small diameter part and a second tapered part connecting the large diameter part and the small diameter part of the stepped shaft;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first tapered part or the second part; and
lubricating oil filled in small gaps formed between facing surfaces adjacent to the first dynamic pressure groove, the second dynamic pressure groove, and the third dynamic pressure groove.

8. The fluid dynamic bearing mechanism of claim 7 further comprising:
an annular groove formed in the cylindrical hole;
a circular groove formed on the stepped shaft; and
an annular ring straddling the annular groove and the circular groove to prevent the stepped shaft from slipping out of the cylindrical hole.

9. The fluid dynamic bearing mechanism of claim 8 further comprising:
a widened section formed in the large diameter part of the cylindrical hole to form a widened seal part.

10. A fluid dynamic bearing mechanism comprising:
a cylindrical bearing case;
a stepped cylindrical hole formed in the bearing case, the cylindrical hole having a large diameter part, a small diameter part and an expanded diameter part, the expanded diameter part having a step part;
an end plate that seals one end of the bearing case to form a bearing housing;
a stepped shaft inserted in the bearing housing, the shaft having a large diameter part and a small diameter part;
a thrust ring fit on the stepped shaft, the thrust ring being received into the expanded diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either an inner surface of the end plate or a bottom surface of the thrust ring;
a fourth dynamic pressure groove formed on either the step part or the top surface of the thrust ring facing the step part; and
lubricating oil filled in small gaps formed between facing surfaces adjacent to the first dynamic pressure groove, the second dynamic pressure groove, the third dynamic pressure groove and the fourth dynamic pressure groove.

11. The fluid dynamic bearing mechanism of claim 10 further comprising:
a widened section formed in the large diameter part of the cylindrical hole to form a widened seal part.

12. A fluid dynamic bearing mechanism comprising:
a cylindrical bearing case;
a stepped cylindrical hole formed in the bearing case, the cylindrical hole having a large diameter part, a small diameter part and an expanded diameter part on one end of the cylindrical hole, a first step part being formed at the junction of the large diameter part and the small diameter part of the cylindrical hole and a second step part being formed at the junction of the small diameter part and the expanded diameter of the cylindrical hole;
an end plate that seals one end of the bearing case to form a bearing housing;
a stepped shaft inserted in the bearing housing, the shaft having a large diameter part, a small diameter part and a third step part at the junction of the large diameter part and the small diameter part of the stepped shaft;
a thrust ring fit on the stepped shaft, the thrust ring being received into the expanded diameter part on the cylindrical hole;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first step part or the third step part;
a fourth dynamic pressure groove formed on either the second step part or a top surface of the thrust ring; and
lubricating oil filled in small gaps formed between facing surfaces adjacent to the first dynamic pressure groove, the second dynamic pressure groove, the third dynamic pressure groove and the fourth dynamic pressure groove.

13. The fluid dynamic bearing mechanism of claim 12 further comprising:
a widened section formed in the large diameter part of the cylindrical hole to form a widened seal part.

14. A fluid dynamic bearing mechanism comprising:
a cylindrical bearing case;
a stepped cylindrical hole formed in the bearing case, the cylindrical hole having a large diameter part, a small diameter part and an expanded diameter part, the expanded diameter part having a step part and the large diameter part and the small diameter part of the cylindrical hole being connected by a first tapered part;
an end plate that seals one end of the bearing case to form a bearing housing;
a stepped shaft inserted in the bearing housing, the shaft having a large diameter part and a small diameter part;
a second tapered part connecting the large diameter part and the small diameter part of the stepped shaft;
a thrust ring fit on the stepped shaft, the thrust ring being received into the expanded diameter part on the cylindrical hole;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first tapered part or the second tapered part;
a fourth dynamic pressure groove formed on either the step part leading to the expanded section of the cylindrical hole or a top surface of the thrust ring; and
lubricating oil filled in small gaps formed between facing surfaces adjacent to the first dynamic pressure groove, the second dynamic pressure groove, the third dynamic pressure groove and the fourth dynamic pressure groove.

15. The fluid dynamic bearing mechanism of claim 14 further comprising:
a widened section formed in the large diameter part of the cylindrical hole to form a widened seal part.

16. A hard disk drive comprising:
a motor having a rotor mounted on a shaft; and
a disk mounted on the rotor, wherein the shaft is supported in a fluid dynamic bearing mechanism comprising:
a cylindrical bearing case;
a cylindrical hole formed in the bearing case, the cylindrical hole having a large diameter part and a small diameter part;
an end plate that seals one end of the bearing case to form a bearing housing;
a stepped shaft inserted in the bearing housing, the shaft having a large diameter part and a small diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either an inner surface of the end plate or a surface of one edge of the stepped shaft; and
lubricating oil filled in small gaps formed between facing surfaces adjacent to the first dynamic pressure groove, the second dynamic pressure groove, and the third dynamic pressure groove.

17. The hard disk drive of claim 16 further comprising:
an annular groove formed in the cylindrical hole;
a circular groove formed on the stepped shaft; and
an annular ring straddling the annular groove and the circular groove to prevent the stepped shaft from slipping out of the cylindrical hole.

18. The hard disk drive of claim 17 further comprising:
a widened section formed in the large diameter part of the cylindrical hole to form a widened seal part.

19. A hard disk drive comprising:
a motor having a rotor mounted on a shaft; and
a disk mounted on the rotor, wherein the shaft is supported in a fluid dynamic bearing mechanism comprising:
a cylindrical bearing case;
a stepped cylindrical hole formed in the bearing case, the cylindrical hole having a large diameter part, a small diameter part and a first step portion formed at the junction of the large diameter part and the small diameter part;
an end plate that seals one end of the bearing case to form a bearing housing;
a stepped shaft inserted in the bearing housing, the shaft having a large diameter part and a small diameter part and a second step portion formed at the junction of the large diameter part and the small diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first step portion or the second step portion; and
lubricating oil filled in small gaps formed between facing surfaces adjacent to the first dynamic pressure groove, the second dynamic pressure groove, and the third dynamic pressure groove.

20. The hard disk drive of claim 19 further comprising:
an annular groove formed in the cylindrical hole;
a circular groove formed on the stepped shaft; and
an annular ring straddling the annular groove and the circular groove to prevent the stepped shaft from slipping out of the cylindrical hole.

21. The hard disk drive of claim 20 further comprising:
a widened section formed in the large diameter part of the cylindrical hole to form a widened seal part.

22. A hard disk drive comprising:
a motor having a rotor mounted on a shaft; and
a disk mounted on the rotor, wherein the shaft is supported in a fluid dynamic bearing mechanism comprising:
a cylindrical bearing case;
a stepped cylindrical hole formed in the bearing case, the cylindrical hole having a large diameter part, a small diameter part and a first tapered part connecting the large diameter part and the small diameter part of the cylindrical hole;
an end plate that seals one end of the bearing case to form a bearing housing;
a stepped shaft inserted in the bearing housing, the shaft having a large diameter part, a small diameter part and a second tapered part connecting the large diameter part and the small diameter part of the stepped shaft;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first tapered part or the second part; and
lubricating oil filled in small gaps formed between facing surfaces adjacent to the first dynamic pressure groove, the second dynamic pressure groove, and the third dynamic pressure groove.

23. The hard disk drive of claim 22 further comprising:
an annular groove formed in the cylindrical hole;
a circular groove formed on the stepped shaft; and
an annular ring straddling the annular groove and the circular groove to prevent the stepped shaft from slipping out of the cylindrical hole.

24. The hard disk drive of claim 23 further comprising:
a widened section formed in the large diameter part of the cylindrical hole to form a widened seal part.

25. A hard disk drive comprising:
a motor having a rotor mounted on a shaft; and
a disk mounted on the rotor, wherein the shaft is supported in a fluid dynamic bearing mechanism comprising:
a cylindrical bearing case;
a stepped cylindrical hole formed in the bearing case, the cylindrical hole having a large diameter part, a small diameter part and an expanded diameter part, the expanded diameter part having a step part;
an end plate that seals one end of the bearing case to form a bearing housing;
a stepped shaft inserted in the bearing housing, the shaft having a large diameter part and a small diameter part;
a thrust ring fit on the stepped shaft, the thrust ring being received into the expanded diameter part;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either an inner surface of the end plate or a bottom surface of the thrust ring;
a fourth dynamic pressure groove formed on either the step part or the top surface of the thrust ring facing the step part; and
lubricating oil filled in small gaps formed between facing surfaces adjacent to the first dynamic pressure groove, the second dynamic pressure groove, the third dynamic pressure groove and the fourth dynamic pressure groove.

26. The hard disk drive of claim 25 further comprising:
a widened section formed in the large diameter part of the cylindrical hole to form a widened seal part.

27. A hard disk drive comprising:
a motor having a rotor mounted on a shaft; and
a disk mounted on the rotor, wherein the shaft is supported in a fluid dynamic bearing mechanism comprising:
a cylindrical bearing case;
a stepped cylindrical hole formed in the bearing case, the cylindrical hole having a large diameter part, a small diameter part and an expanded diameter part on one end of the cylindrical hole, a first step part being formed at the junction of the large diameter part and the small diameter part of the cylindrical hole and a second step part being formed at the junction of the small diameter part and the expanded diameter of the cylindrical hole;
an end plate that seals one end of the bearing case to form a bearing housing;
a stepped shaft inserted in the bearing housing, the shaft having a large diameter part, a small diameter part and a third step part at the junction of the large diameter part and the small diameter part of the stepped shaft;
a thrust ring fit on the stepped shaft, the thrust ring being received into the expanded diameter part on the cylindrical hole;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first step part or the third step part;
a fourth dynamic pressure groove formed on either the second step part or a top surface of the thrust ring; and
lubricating oil filled in small gaps formed between facing surfaces adjacent to the first dynamic pressure groove, the second dynamic pressure groove, the third dynamic pressure groove and the fourth dynamic pressure groove.

28. The hard disk drive of claim 27 further comprising:
a widened section formed in the large diameter part of the cylindrical hole to form a widened seal part.

29. A hard disk drive comprising:
a motor having a rotor mounted on a shaft; and
a disk mounted on the rotor, wherein the shaft is supported in a fluid dynamic bearing mechanism comprising:
a cylindrical bearing case;
a stepped cylindrical hole formed in the bearing case, the cylindrical hole having a large diameter part, a small diameter part and an expanded diameter part, the expanded diameter part having a step part and the large diameter part and the small diameter part of the cylindrical hole being connected by a first tapered part;
an end plate that seals one end of the bearing case to form a bearing housing;
a stepped shaft inserted in the bearing housing, the shaft having a large diameter part and a small diameter part;
a second tapered part connecting the large diameter part and the small diameter part of the stepped shaft;
a thrust ring fit on the stepped shaft, the thrust ring being received into the expanded diameter part on the cylindrical hole;
a first dynamic pressure groove formed on the outer circumferential surface of either the large diameter part of the cylindrical hole or the large diameter part of the stepped shaft;
a second dynamic pressure groove formed on the outer circumferential surface of either the small diameter part of the cylindrical hole or the small diameter part of the stepped shaft;
a third dynamic pressure groove formed on either the first tapered part or the second tapered part;
a fourth dynamic pressure groove formed on either the step part leading to the expanded section of the cylindrical hole or a top surface of the thrust ring; and
lubricating oil filled in small gaps formed between facing surfaces adjacent to the first dynamic pressure groove, the second dynamic pressure groove, the third dynamic pressure groove and the fourth dynamic pressure groove.

30. The hard disk drive of claim 29 further comprising:
a widened section formed in the large diameter part of the cylindrical hole to form a widened seal part.
